(19) United States
(12) Patent Application Publication
(10) Pub. No.: US 2025/0121356 A1
(43) Pub. Date: Apr. 17, 2025

(54) Biodegradable Absorbent Materials and Articles of Manufacture Formed Therefrom

(71) Applicant: Soane Materials LLC, Miami, FL (US)

(72) Inventors: David S. SOANE, Coral Gables, FL (US); Allison Hope GREENE, Reno, NV (US); Juan Sebastian COLMENARES, Reno, NV (US); Delilah M. LUBARSKY, Miami, FL (US); Sydney GREENOUGH HIGGINS, Miami, FL (US)

(21) Appl. No.: 18/911,669

(22) Filed: Oct. 10, 2024

Related U.S. Application Data
(60) Provisional application No. 63/543,581, filed on Oct. 11, 2023.

(51) Int. Cl. B01J 20/28; B01J 20/24; B01J 20/30

(52) U.S. Cl. CPC B01J 20/28038; B01J 20/24; B01J 20/28035; B01J 20/30

(57) ABSTRACT

The present invention provides biodegradable absorbent materials comprising a cellulosic substrate material comprising a lignocellulose material, one or more water-swellable absorbent substances, and one or more additives selected from the group consisting of performance-improving additives, additives to produce specific functionalities, plasticizers, and surfactants; and also provides useful articles of manufacture incorporating such materials. The present invention further provides methods for producing such materials and methods for producing such useful articles of manufacture.

### RELATED APPLICATION

This application claims the benefit of U.S. Provisional Application 63/543,581, filed Oct. 11, 2023. The entire contents of the above application are incorporated by reference herein.

### FIELD OF THE INVENTION

This application relates to biodegradable absorbent composite materials, and articles formed that comprise such materials.

### BACKGROUND

Absorbent materials are characterized by their ability to take up and retain fluids. Such products address multiple needs in the economy, both by removing undesirable liquids from the environment to allow their sequestration and disposal, and by retaining beneficial liquids and delivering them where and when they can be used. Articles of manufacture formed from such materials exist in multiple markets. Absorbent materials used to remove and sequester undesirable liquids find applications (without limitation) in personal care products, pet care products, food packaging, environmental cleanup, and industrial spill and waste management. Absorbent materials used to retain and deliver beneficial liquids find applications (without limitation) in agricultural and horticultural products, healthcare products, and personal care products.

Conventional absorbent materials have been available for use in articles of manufacture for over fifty years. A key component of many conventional absorbent materials is the use of superabsorbent polymers (SAP), specialized crosslinked polymeric networks that can absorb many times their weight in liquid while themselves remaining intact in the presence of the liquid that they retain. SAPs were originally developed by the U.S. Department of Agriculture (USDA) as a soil amendment intended to improve water retention and water conservation for agricultural uses. It was discovered that early forms of SAPs were able to absorb over 400 times their weight in water, and that they tended to retain the liquid better than other types of absorbents. As private companies expanded upon the USDA research, they developed other types of SAP polymers, which were subsequently commercialized—not for agricultural purposes as the USDA originally envisioned, but for personal care items. The first products employing SAPs were disposable hygiene products for menstrual use and for adult incontinence. Use in baby diapers soon followed, and by the 1980s myriad SAP-based products were available globally.

Conventional absorbent products typically rely on synthetic absorbent elements such as SAPs to absorb and retain moisture. In a baby diaper, for example, SAPs can account for 15% to 45% of the weight of the dry diaper; their weight percentage increases significantly as liquid is absorbed, often exceeding 50% of the weight of a wet diaper. Other synthetic materials found in conventional absorbent products can include: (1) synthetic fibers such as polypropylene (PP) and polyethylene (PE), which are involved in absorbency performance by providing structural support, moisture distribution, and support for the SAP elements within the material; (2) nonwoven fabrics also made from synthetic fibers such as PP, PE, polyacrylates, and polyesters, which are used for the outer and inner layers of the absorbent product; and (3) plastic backsheets, typically made of PP or PE, which provide a moisture-impermeable barrier to confine liquids to the absorbent areas of the product and prevent leakage outside the product.

Conventional absorbent products have been enormously successful, meeting important and wide-ranging consumer needs. For example, the global baby diaper market had an estimated value of 82.49 billion USD in 2022, and is expected to grow at a compound annual growth rate (CAGR) of 4.9% from 2023 to 2030 (https://www.grandviewresearch.com/industry-analysis/baby-diapers-market #:˜:text=The %20global %20baby %20diapers %20market,4.9%25%20from %202023%20t o%202030). Other absorbent products categories also serve multi-billion-dollar markets. The success of these products reflects increasing demand in the marketplace for convenient ways to deal with managing and disposing of undesirable liquids. In addition, these synthetic materials are known for their high performance and dependability. Significantly, these conventional products derive many of their advantages from the materials used to manufacture them.

As mentioned above, conventional absorbent materials are made predominantly or entirely from synthetic materials such as SAPs, PP, PE, polyacrylates, and polyesters. SAPs in common use are typically formed synthetically from acrylate monomers. The acrylate monomers themselves are derived from petrochemical sources and are considered a non-renewable resource that is dependent on the petroleum industry. Moreover, the processes required to form SAPs from the acrylate monomers is energy-intensive, entailing expense and imposing environmental burdens. Most importantly, however, SAPs are resistant to biodegradation. Polyethylene and polypropylene, like SAPs, are non-renewable resources dependent on the petroleum industry and requiring significant energy input to create. In addition, they are non-biodegradable.

Products made from these materials, while offering convenient ways to deal with unwanted fluids and waste materials, impose significant burdens on the environment, mainly due to their resistance to decomposition. As an example, it is estimated that a discarded disposable diaper made from conventional synthetic materials will take approximately 450 years to decompose in a waste site such as a landfill. Synthetic plastic materials used to form conventional absorbent articles can also become fragmented into smaller, durable microplastic particles, which are known to enter waterways and land-based ecosystems, potentially affecting marine life, animal ecosystems, and human health.

Biodegradable alternatives have been developed for use in absorbent materials, with the goal of replacing the synthetic materials used conventionally. While the adoption of biodegradable absorbent materials is increasing (a global market valuation of $2.6 billion USD was estimated for baby diapers in 2022, with predicted CAGR of 8.9% by 2028 (https://www.imarcgroup.com/biodegradable-diapers-market), conventional, non-biodegradable products still predominate. This is in large part due to the superior performance of conventional synthetic materials. Conventional disposable diapers, for example, incorporate performance features that result in extended dryness and reduced leakage, attributes that consumers are reluctant to give up when offered more eco-friendly alternatives. Although substitutes for conventional SAPs and synthetic polymers exist that are derived from natural sources, these substitutes tend not to provide the same high performance as the conventional synthetic materials.

There remains a need in the art therefore, for an alternative to conventional synthetic absorbent products that has comparable performance to synthetic materials but without having a deleterious effect on the environment. Such alternatives can desirably be derived from natural sources, using manufacturing processes that impose less stress on the environment. Furthermore, such alternatives are desirably biodegradable, so that they can be disposed of by natural decomposition within a manageable period of time. Also, desirably, a natural and biodegradable superabsorbent polymer can be readily integrated into existing manufacturing processes for absorbent articles as a replacement for SAPs, thus avoiding capital expenditures and streamlining the path to commercialization and disposal with less stress imposed on the environment, while providing the consumer with similar performance as synthetic polymers. Advantageously, the biodegradable absorbent materials offered as alternatives to conventional synthetic materials can be used in multiple applications, both for removing undesirable liquids from the environment to allow their sequestration and disposal, and for retaining and dispensing beneficial liquids in a location where they can be used.

### SUMMARY

Disclosed herein, in embodiments, are biodegradable absorbent materials, comprising a cellulosic substrate material comprising a lignocellulosic material; one or more water-swellable absorbent substances; and one or more additives selected from the group consisting of performance-improving additives, additives to produce specific functionalities, plasticizers, and surfactants. In embodiments, the lignocellulosic material is selected from the group consisting of virgin biomass materials, agricultural waste materials, waste materials from agriculture, forestry, and forestry pulp products, tree-free pulp products, and specialty purpose crop materials. In embodiments, the lignocellulosic material is an agricultural waste material. In embodiments, the one or more water-swellable absorbent substances comprises a polysaccharide polymer, and the polysaccharide polymer can be selected from the group consisting of xanthan gum, pectin, amylopectin, carrageenan, alginate and alginate derivatives, agar-agar, cellulose gum, carboxyalkyl celluloses, cellulose derivatives, pectin ester, gums, and modifications or mixtures of any of the foregoing. In embodiments, the polysaccharide polymer comprises a mixture of hydroxyethyl cellulose and hydroxypropyl methyl cellulose. In embodiments, the one or more additives comprises a performance-improving additive. In embodiments, the performance-improving additive comprises fibers or fillers, and the fibers or fillers can be nanoscale fibers or nanoscale fillers. In embodiments, the nanoscale fibers are cellulose nanofibers (NFCs) or cellulose microfibers (MFCs), or combinations thereof. In other embodiments, the performance-improving additive comprises redispersible NFCs, redispersible MFCs, or a combination of redispersible NFCs and MFCs. In embodiments, at least one of the redispersible NFCs and redispersible MFCs has been rendered redispersible by the addition of a drying/dispersal additive to a formulation comprising NFCs or MFCs, wherein the drying/dispersal additive is selected from the group consisting of temperature-responsive polymers, small molecule additives in volatile systems, and blocking agents. In embodiments, the one or more additives comprises an additive to produce specific functionalities, and the additive can an odor-related additive, which can be an odor controller, or can be an antimicrobial agent, or can be a clumping-producing additive or an indicator additive.

Also disclosed herein, is a biodegradable absorbent material, comprising a cellulosic substrate comprising a lignocellulosic material; a water-swellable absorbent polysaccharide polymer mixture, wherein the polysaccharide polymer mixture comprises hydroxyethyl cellulose and hydroxypropyl methylcellulose, and wherein the water-swellable absorbent polysaccharide polymer mixture permeates the cellulosic substrate; and one or more additives selected from the group consisting of performance-improving additives, additives to produce specific functionalities, plasticizers, and surfactants, wherein the one or more additives permeate the biodegradable absorbent material. In embodiments, the lignocellulosic material is selected from the group consisting of virgin biomass materials, agricultural waste materials, waste materials from agriculture, forestry, and forestry pulp products, tree-free pulp products, and specialty purpose crop materials. In embodiments, the lignocellulosic material is an agricultural waste material. In embodiments, the one or more additives comprises a performance-improving additive. In embodiments, the performance-improving additive comprises fibers or fillers, and the fibers or fillers can be nanoscale fibers or nanoscale fillers. In embodiments, the nanoscale fibers are cellulose nanofibers (NFCs) or cellulose microfibers (MFCs), or combinations thereof. In other embodiments, the performance-improving additive comprises redispersible NFCs, redispersible MFCs, or a combination of redispersible NFCs and MFCs. In embodiments, at least one of the redispersible NFCs and redispersible MFCs has been rendered redispersible by the addition of a drying/dispersal additive to a formulation comprising NFCs or MFCs, wherein the drying/dispersal additive is selected from the group consisting of temperature-responsive polymers, small molecule additives in volatile systems, and blocking agents. In embodiments, the one or more additives comprises an additive to produce specific functionalities, and the additive can an odor-related additive, which can be an odor controller, or can be an antimicrobial agent, or can be a clumping-producing additive or an indicator additive.

Also disclosed herein, in embodiments, are articles of manufacture comprising the biodegradable absorbent material described herein. In embodiments, the article is formed as a sheet or a film, or is formed as a pellet, granule, bead, sphere, hemisphere, cylinder, strand, or cube. In embodiments, the article can be a fluid-removal product, which can be a pet-care product; the pet-care product can be a cat litter product. In embodiments, the article can be a fluid-delivering product, which can comprise dried or partially dried absorbent material that absorbs a rewetting fluid and delivers it secondarily to a designated target area. In embodiments, the fluid-delivering product delivers a personal care product in fluid form to a targeted body surface. In embodiments, the fluid-delivering product delivers an active agent to a targeted site; in embodiments, the active agent is a pharmaceutical agent or a personal care active agent. In embodiments, the fluid-delivering product is adapted for transdermal delivery of the active agent. In embodiments, the article of manufacture, which can further comprise an additive selected from the group consisting of nutrients, seeds, pesticides, and pheromones, is adapted for use in an agricultural or horticultural setting. In embodiments, the article is pre-infused with fluid for delivery to an agricultural target. Such an article formed as a sheet or a film can further comprise a water-resistant layer on the outward-facing side of the article. In embodiments, the article further comprises an additive selected from the group consisting of nutrients, seeds, pesticides, and pheromones.

Further disclosed herein, in embodiments, are methods of preparing a material having water-swellable absorbent properties, comprising providing a first aqueous solution comprising hydroxyethyl cellulose and hydroxypropyl methyl cellulose; providing a second aqueous solution comprising glycerol and at least one additive; mixing the first aqueous solution and the second aqueous solution to form a binary absorption solution; adding a cellulosic substrate material to the binary absorption solution; and mixing the cellulosic substrate product and the binary absorption solution to form a material having water-swellable absorbent properties. In certain practices of the method, the hydroxyethyl cellulose and the hydroxypropyl methylcellulose are provided in a ratio from about 50:50 to about 95:5. In embodiments, the at least one additive is selected from the group consisting of a plasticizer, an odor-related or odor-controlling agent, a clumping-producing additive, and an indicator additive. In embodiments, the cellulosic substrate material comprises non-redispersible or redispersible nanocellulose elements, and the nanocellulose elements can be added at concentrations ranging from about 1 wt % to about 10 wt %. In embodiments, the cellulosic substrate material comprises agricultural waste. Methods are also disclosed herein for preparing a formed article comprising a material having water-swellable absorbent properties, comprising preparing the material having water-swellable properties according to the methods set forth above to provide a precursor material for the article of manufacture, and shaping the formed article to yield a finished article of manufacture. In embodiments, the formed article can be further processed to yield a finished article of manufacture, and the step of further processing can be selected from the group consisting of drying processes, coating process, molding processes, and printing processes. In embodiments, the step of further processing produces a spherical or ovoid article of manufacture having a size range from about 0.1 mm to about 10 mm.

Disclosed herein, in embodiments, are biodegradable absorbent materials, comprising a cellulosic substrate material; one or more water-swellable absorbent substances; and one or more additives selected from the group consisting of performance-improving additives, additives to produce specific functionalities, plasticizers, and surfactants. In embodiments, the cellulosic substrate material is selected from the group consisting of virgin biomass materials, agricultural waste materials, waste materials from forestry, and specialty purpose crop materials. In embodiments, the cellulosic substrate material is an agricultural waste material. In embodiments, the one or more water-swellable absorbent substances comprises a polysaccharide polymer, and the polysaccharide polymer can be selected from the group consisting of xanthan gum, pectin, amylopectin, carrageenan, alginate and alginate derivatives, agar-agar, cellulose gum, celluloses, pectin ester, gums, and modifications or mixtures of any of the foregoing. In embodiments, the one or more additives comprises a performance-improving additive, and the performance-improving additive comprises NFCs, MFCs, or a combination of NFCs and MFCs. In other embodiments, the performance-improving additive comprises redispersible NFCs, redispersible MFCs, or a combination of redispersible NFCs and MFCs. In embodiments, at least one of the redispersible NFCs and redispersible MFCs has been rendered redispersible by the addition of a drying/dispersal additive to a formulation comprising NFCs or MFCs, wherein the drying/dispersal additive is selected from the group consisting of temperature-responsive polymers, small molecule additives in volatile systems, and blocking agents. In embodiments, the one or more additives comprises an additive to produce specific functionalities, and the additive is an odor-related additive; the odor-related additive can be an odor controller.

Also disclosed herein, in embodiments, are articles of manufacture comprising the biodegradable absorbent material described above. In embodiments, the article can be a fluid-sequestering product, which can be a pet-care product; the pet-care product can be a cat litter product. In embodiments, the article can be a fluid-delivering product, which can be used in an agricultural or horticultural setting, and which can be formed as a sheet or a film. Such an article formed as a sheet or a film can further comprise a water-resistant layer on the outward-facing side of the article. In embodiments, the article further comprises an additive selected from the group consisting of nutrients, seeds, pesticides, and pheromones. In embodiments, the article is pre-infused with fluid for delivery to an agricultural target.

### DETAILED DESCRIPTION

A. Biodegradable Absorbent Materials and their Preparation
a. Substrate Materials

The biodegradable absorbent materials disclosed herein comprise a cellulosic substrate material, in particular those plant-derived cellulosic substrate materials, also known as lignocellulosic materials. Lignocellulosic materials are derived from plants, including the stems, leaves, and woody supporting structures; such materials comprise fibers and structural components formed from cellulose, hemicellulose, and lignin in varying amounts, with cellulose and hemicellulose polymers bound together by the lignin. Plants having use as lignocellulosic materials can be woody (such as trees, with firm stems, and with multiyear growth cycles) or non-woody, having weak stems and annual or limited multiyear growth cycles. Useful lignocellulosic materials can include virgin biomass, as is found in naturally occurring plants like trees, bushes, and grass. Such materials can also include waste materials from consumption or from industries such as agriculture (e.g., corn stover and corncobs, sugarcane bagasse, straw, oil palm empty fruit bunch, pineapple leaf, apple stem, coir fiber, mulberry bark, rice hulls, bean hulls, soybean hulls (or “soyhulls”), cotton linters, blue agave waste, North African glass, banana pseudo stem residue, bamboo fibers, groundnut shells, pistachio nut shells, grape pomace, shea nut shell, passion fruit peels, fique fiber waste, sago seed shells, kelp waste, juncus plant stems, and the like), or waste materials from forestry or from tree-free sources (saw mill and paper mill discards, wood flour, wood chips, saw dust, bagasse pulp, hardwood and softwood pulp, Kraft wood pulp, recycled wood pulp, and the like). Such materials can further include specialty-purpose crops such as switchgrass and elephant grass cultivated for uses such as biofuels, capable of multiple harvests. Common sources of such lignocellulosic materials are agricultural waste materials, or forestry waste materials or forestry pulp products, including lignocellulosic materials such as coffee grounds, wood flour, wood chips, saw dust, bagasse pulp, hardwood and softwood pulp, beet grounds, ground rice hulls, banana fiber, bamboo fiber, lignin, hemp fibers, Kraft wood pulp, recycled wood pulp, or any combination of these.

The biodegradable absorbent materials disclosed herein further comprise and are permeated by one or more absorbent substances. Substances suitable for absorbency are those that can absorb and retain significant amounts of aqueous fluids in relation to their weight in a relatively short period of time. Such substances can also be termed water-swellable. While both natural and synthetic polymers can have water-swellable properties, only those that are biodegradable are suitable for the purposes the instant invention.

In embodiments, a water-swellable polymer can be deployed initially as a solid dispersed in a liquid phase, forming a colloidal suspension of very small solid particles in a continuous liquid medium. A water-swellable polymer can also imbibe water and form a hydrophilic polymer network that ensnares the liquid within the network through surface-tension effects and hydrogen bonding, thus forming a colloidal suspension that is viscous enough to behave like a solid (i.e., a gel). Water-swellable polymeric networks may range from being mildly absorbing, typically retaining relatively small amounts of water (such as about 25-30 wt. %) within their structure, to superabsorbing, where they retain many times their weight of aqueous fluids. When a water-absorbing polymer in combination with the aqueous sorbate forms a stable three-dimensional gel structure, this structure is termed a “hydrogel.”

In other embodiments, the water-absorbing polymer can be added to the absorbent material as a liquid to be mixed in with the cellulosic substrate materials to provide absorbency in the overall biodegradable absorbent material. For example, a water-absorbing polymer can be formulated as an aqueous solution, into which the cellulosic substrate materials and other materials such as fibers, fillers, odor-related additives, and the like (as described below in more detail) can be added; once these components are mixed together, the mixture can be dried, so that the water-absorbing polymers dry around the other components in the solid substance that results from drying the mixture. In such a case, the water-absorbent polymer is initially in a liquid phase, but is dried into a solid phase until it is rewet by the fluids that the absorbent material absorbs.

An important class of naturally-derived water-absorbing polymers for forming biodegradable absorbent materials are polysaccharide polymers, which can provide well-recognized, regulatory-friendly acceptance for personal care and other health and wellness applications. Examples of water-swellable polymers include materials such as xanthan gum, pectin, amylopectin, carrageenan (or including without limitation kappa, iota or lambda carrageenans), alginate and alginates (including without limitation derivatives such as propylene glycol alginate), agar-agar, cellulose gum, celluloses (such as carboxyalkyl celluloses, including but not limited to carboxymethylcellulose, hydroxyethyl cellulose, carboxymethyl hydroxyethyl cellulose, hydroxypropyl methyl cellulose, methyl cellulose, and the like), pectin ester, gums such as gellan gum, guar gum and guar derivatives, gum Arabic, locust bean gum, diutan, welan, tam, olibanum, karaya, ghatti, dammar, tragacanth gum, or modifications or mixtures of any of the foregoing. High viscosity polysaccharides offer advantageous swellable properties, and can be used alone or together with other water-swellable materials. Other desirable biopolymers for use alone or with the aforesaid water-swellable polysaccharides can include starch, modified starches, dextrin, amylase, modified amylase, chitosan, modified chitosan, chitin, modified chitin, gelatin, konjac, modified konjac, fenugreek gum, modified fenugreek gum, mesquite gum, modified mesquite gum, aloe mannans, modified aloe mannans, oxidized polysaccharides, sulfated polysaccharides, cationic polysaccharides, and the like. Polysaccharide polymers that are capable of taking up at least 50 times, at least 100 times, at least 300 times, at least 500 times, at least 800 times, at least 900 times, or at least 1000 times their weight in water are particularly useful. In embodiments, the amount of such an absorbent polymer (on a dry solids basis) that is integrated with the cellulosic substrate can generally be between about 0.1-10 wt. %, or between 0.5-5 wt. % based on the weight of the substrate material. The absorbent polymer can be incorporated into the cellulosic substrate to permeate the cellulosic substrate and to be distributed throughout the cellulosic substrate, with absorbent polymer on a dry weight basis at possible loadings between about 0.1-67%, about 0.1-50%, about 0.1-10%, about 0.1-1%, about 1-10%, about 1-5%, about 5-10%, about 5-20%, about 5-50%, and about 25-67% depending on the application. Within these broad ranges, polymer loadings of about <20 wt %, about <10 wt %, about <5 wt. %, about <4 wt. %, about <3 wt. %, about <2 wt. %, and about <1.5 wt. % can be advantageous.

As used herein, the term “permeate” and related parts of speech refers to the distribution of one substance within another, such that the first substance penetrate, passes into, saturates partially or completely, percolates into, becomes incorporated within, pervades, or otherwise distributes itself or becomes distributed within the second substance to form a composite, mixture, blend, suspension, solution, or other combination of the first substance and the second substance. As an example, in embodiments of the biodegradable absorbent material as disclosed herein, substances such as additives can permeate the biodegradable absorbent material and become distributed within the biodegradable absorbent material. Such additives coming to permeate the biodegradable absorbent material can be introduced as components of either the water-swellable absorbent polysaccharide polymer mixture or the cellulosic substrate; when the water-swellable absorbent polysaccharide mixture and the cellulosic substrate are then mixed together, the additives residing in both components become dispersed within the resulting biodegradable absorbent material. Such distribution of the additives within the biodegradable absorbent material can be even, uneven, deliberately graduated, or varied from region to region within the second substance. In certain embodiments, the distribution of the first substance (e.g., an additive) is relatively uniform and homogeneous throughout the composite. An additive has uniform distribution in the biodegradable absorbent material when the distribution of the additive is the same in all sections of the absorbent material. An additive has substantially uniform distribution when the distribution of the additive is about the same in all sections of the absorbent material, for example, when the amount of additive within each section of the absorbent material is within about 10% of the amount of the additive in each of the other sections (of the same size) of the absorbent material.

Water-swellable absorbent substances for use in the present invention can be combined with the cellulosic substrate material to permeate it, being incorporated as solids, semi-solids, or liquids, depending on the end-use of the material, and depending on how the absorbent substance is to be integrated with the cellulosic substrate. Liquids, for example, can be mixed easily into a less viscous cellulosic substrate, with even distribution of the liquid throughout the cellulosic material. Solids or semi-solids, by contrast, can be positioned in discrete locations within the substrate, or can be organized to produce differential fluid uptake in different areas within the substrate. Other arrangements of absorbent substances within the cellulosic substrate material will be apparent to skilled artisans, and the substances can be selected accordingly.

b. Additives

The biodegradable absorbent materials disclosed herein further comprise and are permeated by one or more additives. Additives can include materials that are intended to improve overall performance, and those that provide specific functionalities. Additives can also include materials such as surfactants and plasticizers that improve the consistency, malleability, and integrity of the absorbent material overall, that can increase redispersibility of the product after being dried, and that decrease the surface tension of the aqueous solution(s) that are mixed together with the solid materials (e.g., the cellulosic substrate materials and other materials such as fibers, fillers, odor-related additives, and the like) in the preparation of the absorbent material. Examples of surfactants and plasticizers useful in these materials include, without limitation, glucosides (capryl, hexyl, lauryl, decyl, coco, and the like), alkyl polyglucosides like GLUCOPON®, polysorbate, polyethylene glycol, polypropylene glycol, PEG/PPG coblock polymers and the like, triglycerin, polyols (glycerol, xylitol, mannitol, sorbitol, maltitol, and the like), polyoxyethylene sorbitans (monopalmitate, monostearate, monooleate, and the like), cocamides (monoethanolamine and diethanolamine), sulfates (sodium coco, sodium dodecyl, sodium lauryl, sodium laureth, sodium octyl, ammonium lauryl, ammonium laureth), sodium lauroyl sarcosinate, sodium caprylyl sulfonate, sodium cocoyl isethionate, C10-16 Pareth, and the like. Examples of additives that intended to improve overall performance and or that provide specific functionalities are provided below.

i. Performance Additives

Performance-improving additives are those that add desirable properties to the biodegradable absorbent material as a whole, relatively independent of its designated purpose. Such a property can be a mechanical property such as improved strength, hardness, toughness, brittleness, stiffness, elasticity, cohesion, durability, impact resistance, tear resistance, shock absorbency, and the like. Certain mechanical properties of the final absorbent product such as strength can be enhanced without additives by selecting stronger pulp stocks for the cellulosic substrate material. Softwood pulp can provide a stronger pulp matrix than hardwood pulp, since hardwood pulp fibers are shorter—resulting in more brittle material; however shorter fibers (as are found in hardwood pulp) can be more cost effective and provide stiffness. For example, tree-free pulps such as bagasse produce stiff pulp matrices as well, and can be used alone or in combination with other pulps, such as a softwood, to improve overall matrix strength. A cellulosic substrate material can also be combined with reinforcing additives such as cellulose fibers, nanofibrillated cellulose (NFC), microfibrillated cellulose (MFC) and non-cellulosic fillers that are added to the composite absorbent material. As used herein, the term “nanofibrillated cellulose” or “cellulose nanofibers” (either, “NFC”) and “microfibrillated cellulose” or “cellulose microfibers” (either, “MFC”) refer to elongated cellulose fibrils that are extracted from plant-derived cellulosic raw materials. Cellulose nanofibers and cellulose microfibers can be distinguished from each other based on their size and shape: cellulose nanofibers are much smaller in diameter than cellulose microfibers and can be straight and rod-like, while cellulose microfibers are larger in diameter, more flexible in appearance and can be irregular in shape. While the literature cites a range of dimensions for NFC and for MFC, both types of fibers are in the nanoscale range. NFC fibers, for example, have a diameter between 4-20 nm, while MFC fibers, though much larger, still have diameters in the nano-range, for example 20-100 nm or larger.

Without being bound by theory, it is envisioned that the fibers of any size (including without limitation cellulose microfibers and cellulose nanofibers) or fillers of any size selected for strengthening purposes can, as ingredients in the composite absorbent material, reinforce it by filling in pores or gaps within the substrate matrix, thus distributing mechanical loads more effectively and providing additional load-bearing points, thereby increasing the strength of the overall composite. Fibers and fillers can also be selected for strengthening a composite absorbent material by creating or lending structure (and therefore strength) to a pre-existing matrix that has been produced in a foamed or porous material. Besides adding strength to such a material, fillers and fibers can also absorb and dissipate energy from impacts, making the composite less prone to fracture and fragmentation.

Thus, the incorporation of fibers or fillers as performance-improving additives can provide sufficient strength to a foamed or porous or otherwise low-density material to allow such a material to be useful for absorbency. As an example of such an arrangement, a low density, foamed absorbent composite material having a matrix comprising a mixture of softwood and hardwood pulp, cellulose nano and/or microfibers, can be prepared from water-swellable polymeric materials, such as, without limitation, hydroxyethyl cellulose, hydroxypropyl methyl cellulose, hydroxypropyl cellulose, alginates, carrageenan, gums, water-swellable polysaccharides, and/or any combination thereof. In embodiments, nanoscale fibers such as cellulose nanofibers and cellulose microfibers and nanoscale fillers, such as nanocellulose elements, lignin, mineral powders, nanoclays such as montmorillonite and nano-sized silica, are performance-improving additives that can add significant reinforcement to the composite and improve the strength thereof, due to the high surface area and aspect ratio of these nanoscale materials.

To compare the relative properties of low-density and high-density absorbent materials, the following demonstration was performed. A formulation was produced by mixing about 90 wt % fiber (e.g., 97% bagasse, 2.5% softwood kraft pulp, 0.5% sawdust), about 5 wt % absorbing polymers (e.g., 80% hydroxyethyl cellulose (HEC), 20% HMPC (hydroxypropyl methylcellulose)), about 5 wt % capryl glucoside and glycerol mixture (e.g., 93% capryl glucoside, 7% glycerol) in water. The fully mixed formulation was then split in half, with one half homogenized using the IKA T25 mixer to yield a foam, and the other half not homogenized. Each half-formulation was shaped in silicone molds to form 0.9 cm³ cubes, which were then baked for 120 min, or until dry, at 85° C. The density of the cubes from each formulation was then measured, and their water absorbency tested. A representative experiment yielded a density of about 0.05 g/cc for the homogenized cubes, which were about 4-5×lighter than the non-homogenized ones, which had a density of about 0.2-0.25 g/cc. In the same representative experiment, the lower-density sample was more efficient at absorbing water by weight. Without being bound by theory, it is believed that the lower density matrix provides more space for the water to get trapped in the water-swellable polymer coated pores.

Advantageous fibers and fillers selected for use as additives in the biodegradable absorbent materials disclosed herein can be natural rather than synthetic substances, for example natural minerals such as kaolin and talc, natural fibers including, without limitation, agricultural waste product such as coffee grounds, wood flour, wood chips, saw dust, bagasse pulp, hardwood and softwood pulp, beet fiber grounds, ground rice hulls, banana fiber, bamboo fiber, lignin, hemp fibers, recycled pulp, or any combination of the foregoing, and biodegradable polymers such as polylactic acid microspheres or polyhydroxyalkanoate particles.

Additives for improving other mechanical properties can be selected based on intended use of the biodegradable absorbent material. For example, under certain circumstances it would be desirable to select fibers or fillers that are relatively insoluble in the fluid to be absorbed, such as water or urine. In embodiments, natural insoluble fibrous materials such as chitosan fibers, alginate fibers, seed fibers, leaf fibers, bast fibers, fruit fibers, stalk fibers, animal fibers, keratin, collagen, modified cellulose fibers and polymers, cellulose acetates, modified starches, cationic starches, and the like, can be used. In other embodiments, small insoluble organic or inorganic particles can be used, such as psyllium husk powder, walnut shell granules, lignin, zein, resin acids, waxes, mineral powders, ground or precipitated calcium carbonate, zinc oxide, titanium dioxide, and the like.

In exemplary embodiments, natural insoluble materials such as nanofibrillated cellulose, microfibrillated cellulose, or crystalline cellulose particles (collectively “nanocellulosic elements” or “NCEs”) can be added to the absorbent material formulation to improve its strength and other properties. As used herein, the term “crystalline cellulose” refers to cellulosic particulate matter derived from the crystalline regions of cellulose chains in plant-derived cellulosic raw materials. Crystalline cellulose can be extracted in particulate form, yielding products that are termed cellulose nanocrystals or cellulose microcrystals, depending on the size of the particles.

NCE strength additives are particularly desirable because they are derived from plant-based cellulosic materials and thus do not detract from the favorable environmental profile of the absorbent composites disclosed herein. Sources for NCEs include, without limitation: virgin biomass, as is found naturally occurring plants like trees, bushes, and grass; waste products from agriculture such as corn stover and corncobs, sugarcane bagasse, straw, oil palm empty fruit bunch, pineapple leaf, apple stem, coir fiber, mulberry bark, rice hulls, bean hulls, soybean hulls (or “soyhulls”), cotton linters, blue agave waste, North African grass, banana pseudo stem residue, bamboo fiber, groundnut shells, pistachio nut shells, grape pomace, shea nut shell, passion fruit peels, fique fiber waste, sago seed shells, kelp waste, juncus plant stems, and the like; waste products from forestry, including discards from sawmills and paper mills; and special-purpose crops such as switchgrass and elephant grass that are cultivated for uses such as biofuels.

Enhancing the properties of composite materials using NCEs has already been contemplated in industry, but their use has been hampered by redispersion problems that are familiar in the art. While the nano-size geometry and hydrophilic nature of these cellulosic materials offer opportunities for using them in industry, these features also present challenges. Limitations imposed by NC drying and dispersion techniques often restrict the usefulness of these materials for commercial applications.

NCEs are usually produced by a series of mechanical and/or chemical procedures performed in an aqueous medium, whereby the aqueous suspension loosens cellulose's interfibrillar hydrogen bonding to facilitate delamination, resulting in the formation of NC derivatives having more useful degrees of polymerization and crystallinity and having higher aspect ratios. Typically, NC materials are then dispersed in the aqueous medium at a low concentration (<5 wt %) because their high water-absorption capacity cause them to form a highly viscous suspensions even at low solid concentrations, due to the entangling of the high-aspect-ratio NC elements. However, these aqueous suspensions of NCs are difficult to manage and expensive to transport.

Drying technologies have been devised to convert the NC suspension into a dry powder form, but drying the NC suspension using conventional techniques (for example, evaporating the water at high temperatures) promotes the formation of aggregates due to the interaction of hydroxyl groups on the surface of the cellulose molecules and the formation of hydrogen bonds. This aggregation process resulting from conventional drying, termed hornification, is characterized by irreversible or only partially reversible bonding between the hydroxyl groups on the NC particles or fibers. While various drying techniques, e.g., freeze drying, spray drying, supercritical fluid drying and atomization, have been investigated by researchers, they have at best yielded small samples of redispersed NC elements, using processes whose high cost, energy requirements, and need for specialized equipment preclude their widespread adoption. While NC elements prepared with conventional techniques can be used as strength-enhancing additives in accordance with the present invention, the use of such materials is encumbered by the limitations described above: to overcome these limitations, conventionally prepared NCE formulations are typically transported and employed as dilute aqueous solutions.

As an alternative, NC fibers can be provided in a conveniently accessible dried form using the redispersion technology disclosed in U.S. patent application Ser. No. 17/834,521, filed Jun. 7, 2022, published as US20220412010A1 (the “'521 application,” the contents of which are incorporated by reference herein). According to the '521 Application, NCE fibers can be treated and rendered redispersible in accordance with the methods disclosed therein. Such fibers, rendered redispersible according to the teachings of the '521 application, do not undergo hornification when they are dried; these NC fibers can be used in a dried form and then redispersed to become integrated into the biodegradable absorbent material without becoming agglomerated, or they can be redispersed to produce a liquid formulation of any concentration that can be added to another substance, such as the biodegradable absorbent material. In more detail, dried NC-containing materials can be produced as follows. First, a liquid formulation can be prepared comprising a suspension of nanocellulose (NC) elements and a drying/dispersal additive, wherein the drying/dispersal additive is selected from the group consisting of temperature-responsive polymers, small molecule additives in volatile systems, and blocking agents. This liquid formulation can then be dried, or can be added to another substance, such as the biodegradable absorbent materials disclosed herein, so that the NCEs it contains become incorporated into the substrate. When the liquid formulation described above is dried, the redispersibility of the dried NC-containing material is greater than that of a dried control material prepared by drying a control suspension of nanocellulose elements in a liquid medium, wherein the control suspension lacks a drying/dispersal additive.

Redispersion technologies as have been described in the '521 application facilitate the transportation of NCE compositions or formulations that can then be resuspended to be combined with or integrated into other substrates such as the biodegradable absorbent materials of the present invention, yielding composite materials. In embodiments, these redispersion technologies can produce a uniform mixture of high-aspect-ratio NCEs within the cellulosic substrate material, allowing enhancement of performance-related properties such as improved strength, hardness, toughness, brittleness, stiffness, elasticity, cohesion, durability, impact resistance, tear resistance, shock absorbency, and the like. Thus, while redispersibility is not a necessary property for NCEs to be used in the biodegradable absorbent material, redispersed/redispersible NCEs offer distinct advantages for logistics and for handling, and thus can be a particularly advantageous additive to improve overall performance of the biodegradable absorbent materials disclosed herein. As an example, in embodiments, the virgin, redispersible, or redispersed NCEs can be loaded in an absorbent composite material, to add strength, stiffness, and/or abrasiveness, at about 0.1-25% on a dry weight basis, for example about 0.1-10% or about 0.5-5%.

ii. Specific Functionalities Additives

Additives providing specialized functionalities are those that add desirable properties to the biodegradable absorbent material so that it achieves a designated, specialized purpose apart from its absorbency and related performance features. For example, additives improving manageability of the biodegradable absorbent material during its preparation and manipulation include ingredients such as surfactants and plasticizers that make it easier to mix the components of the material, mold them into desired shapes, add desirable properties such as flexibility, or preserve them in the form that has been selected. Other improvements such as improved consistency, malleability, and integrity of the absorbent material overall can be provided by such additives. Surfactants can also act as foaming agents to help encourage a lower density structure, especially when subjected to high shear mixing and aeration.

Surfactants may also be active agents loaded into the matrix to be released/activated/deposited, when the article absorbs water. Examples of surfactants and plasticizers include, without limitation, glucosides (capryl, hexyl, lauryl, decyl, coco, and the like), alkyl polyglucosides like GLUCOPON®, polysorbate, polyethylene glycol, polypropylene glycol, PEG/PPG coblock polymers and the like, triglycerin, polyols (glycerol, xylitol, mannitol, sorbitol, maltitol, and the like), polyoxyethylene sorbitans (monopalmitate, monostearate, monooleate, and the like), cocamides (monoethanolamine and diethanolamine), sulfates (sodium coco, sodium dodecyl, sodium lauryl, sodium laureth, sodium octyl, ammonium lauryl, ammonium laureth), sodium lauroyl sarcosinate, sodium caprylyl sulfonate, sodium cocoyl isethionate, C10-16 Pareth, and the like.

As another example, an odor-related additive can be included in a biodegradable absorbent material that will be used for the absorption of odoriferant substances, for example for the absorption of malodorous fluids such as bodily wastes. An odor-related additive can also be used for absorbent materials that are intended to absorb fluids that will decompose to become putrid after being absorbed, thereby absorbing the odoriferant substances that such decomposed materials produce. In certain embodiments, an odor-related additive is intended to mask odors associated with the absorbed fluids, while in other embodiments, the odor-related additive is intended to deodorize the odor. In yet other embodiments, the odor-related additive is intended to provide a desirable scent that can be generated for aesthetic purposes (such as a fragrance) or for veterinary or agricultural purposes (such as a pheromone or an insect repellant). Some examples of odor-related additives for absorbing or masking odoriferant substances include, without limitation, activated carbon, activated charcoal, silicone dioxide, sodium bicarbonate, acetic acid, bentonites, proteases and amylases, and polyamines.

In embodiments, antimicrobial additives, including antibacterial and antifungal additives and antioxidants, can be added to the biodegradable absorbent material to slow degradation and control the evolution of unpleasant odors. Exemplary antioxidant additives include, without limitation, ascorbic acid, butylated hydroxyanisole, butylated hydroxytoluene, citric acid, sulfites, tertiary butylhydroquinone, tocopherols, and the like. A variety of additives can be selected to prevent bacterial, fungal and/or microbial activity, degradation, and related odors in the biodegradable absorbent material. Exemplary antimicrobial agents include, without limitation, organic acids such as lactic acid, acetic acid, sorbic acid, benzoic acid, propionic acid, polyphenols, E-cinnamaldehyde, essential oils, lignin, chitosan, nisin, natamycin, nitrates, nitrites, sulfites, sulfur dioxide, sodium chloride, peptides (e.g. lactoferrin, pleurocidin, defensins, protamine, magainin, and casocidin), glycoproteins, enzymes (e.g. lysozyme), and the like. Antibacterial agents include, without limitation, boric acid, sodium borate (borax), Phenoxyethanol (NEOLONE™), silica, and the like. In addition, odor-related additives can be added to the formulation, such as (without limitation) sodium carbonate, sodium bicarbonate, activated charcoal, enzymes (such as, without limitation, proteases and amylases), acetic acid, silica, bentonites, polyamines, modified polyamines, and the like. The category of suitable polyamines can include amine-containing polysaccharides, amine-containing polypeptides, polyethylenimine, polyethylenimine derivatives, poly(vinylamine), poly(diallylamine), poly(allylamine), copolymers of diallylamine and allylamine, copolymers containing diallylamine or allylamine, and condensation polymers formed from polyamine monomers and monomers with two or more amine-reactive groups. Additionally, fragrances, naturally scented oils, encapsulated fragrances (for example, using cyclodextrins) can provide odor control and preferred scent.

Other additives providing specialized functionalities are materials such as olivine that can be used for CO₂ absorption and consequent environmental remediation. Olivine is a mineral capable of absorbing/adsorbing CO₂ from the atmosphere, and can be deployed to lie on top of a surface such as a sheet, or a series of non-contiguous sheets or other vehicles formed from the biodegradable absorbent material of the present invention. Olivine can also be sprayed on the surface of a particulate matter comprising biodegradable absorbent material, so that the particulate matter absorbs CO₂ from the air. Such particles can be broadcast or otherwise spread or dispersed over agricultural or horticultural environments, carrying beneficial substances like nutrients and fertilizers to the agricultural targets as described below, but also carrying olivine on their surfaces to trap CO₂ being released into the atmosphere. The particles formed from the biodegradable absorbent material can be engineered so that they biodegrade when the olivine becomes saturated, so that the olivine-CO₂ complex disintegrates into the local environment and harmlessly captures and retains the CO₂ in the soil.

For specialized absorbent products such as cat litter, additives can be selected to encourage clumping. These clumping-producing additives include, without limitation: clays and minerals such as sodium bentonite and calcium bentonite; gums such as guar, agar, xanthan, locust bean, and the like; alginates; gelling cellulose derivatives such as HEC (hydroxyethyl cellulose), EC (ethyl cellulose), HPMC (hydroxypropyl methylcellulose, HEC (hydroxypropyl cellulose), MC (methylcellulose), CMC (carboxymethyl cellulose), NaCMC (sodium carboxymethyl cellulose), and the like; cellulose and nanocellulose elements, dextrin, starches, soy fibers, xyloglucan, crosslinking agents such as ionically or partially charged polymers, polysaccharides and modified polysaccharides, NaCMC, chitosan, and the like, and mono- and polycarboxylic acids (glycolic, citric, succinic, adipic, fumaric, malic, maleic, glutaric, acrylic, and the like). Additionally, to provide dust control in such products, especially when using mineral powders and clays as clumping additives, mineral oils can be added to the formulation. Clumping for cat litter and similar pet waste absorbers also decreases likelihood of individual wet pellets adhering to the animal's fur, as they adhere more strongly to one another than to the hair shafts, and they are less likely to remain attached to the fur because their density has increased from absorbing waste. To further prevent the wet or dry pellets from sticking to an animal's fur, anionic additives (polymers, surfactants, and the like) can be selected to repel keratin, the negatively-charged protein that is the main component of cat hair. The negative charge in the additive and the nature of the surfactant will decrease surface tension within the clumped material and will discourage adhesion between cat fur and the litter, whether the product is wet or dry. As examples, anionic surfactants such as sodium dodecyl sulfate, sodium lauryl sulfate, sodium laureth sulfate, sodium lauroyl sarcosinate, sodium methyl cocoyl taurate powder, sodium coco sulfate, sodium cocoyl isethionate, sodium lauroyl methyl isethionate, sodium caprylyl sulfonate, sodium octyl sulfate, ammonium lauryl sulfate, ammonium laureth sulfate, and the like can be used.

Indicator additives may also be added to the cat litter formulation. These additives can change colors to indicate changes or presence of pH and ammonia. Further additives, such as animal attractants (catnip, pheromones and the like), fragrances, pigments and dyes can be added and tuned to meet animal and/or consumer preferences.

c. Substrate Preparation

Once the cellulosic substrate material and the absorbent substances have been selected for a specific product, along with the appropriate additives, the ingredients can be mixed to produce the precursor material that can be further shaped to form useful articles of manufacture. For example, the ingredients can be mixed together to form a malleable substance that can be shaped into a configuration such as a sheet, a three-dimensional article, a plurality of strands, a hollow tube, or any other form that is appropriate for the designated use of the material.

As an example, a water-swellable absorbent substance or mixture thereof such as HEC:HPMC, prepared in mixtures from about 50:50 to about 95:5 HEC:HPMC (in parts by weight) for example, an HEC:HPMC ratio of about 1:1, about 3:1, about 4:1, about 5:1, about 6:1, about 7:1, about 8:1, about 9:1, about 10:1, about 11:1, about 12:1, about 13:1, about 14:1, about 15:1, about 16:1, about 17:1, about 18:1, or about 19:1, can be combined with any other desirable additives, as disclosed herein. For example, additives such as a population of NCEs, whether the non-redispersible or redispersible/redispersed NCEs described above, an odor-related additive, and a plasticizer such as glycerol can first be combined to form an additive mixture. This additive mixture can then be whisked to create a homogenous solution that can be combined with the previously-prepared cellulosic substrate material, again blended to achieve homogeneity.

In more detail, a base absorbent substance can be prepared with polymers with molecular weights ranging from tens of thousands g/mol to millions g/mol, with the specific polymer(s) selected for optimal physical integrity; advantageously, high molecular weight versions of the absorbent polymers can be selected (for example, in molecular weight ranges from a hundred thousand g/mol to millions g/mol). For example, a glycerol in water solution can be prepared that includes a surfactant, to which solution HEC and HPMC are added and mixed until the solution is homogeneous. To this solution, non-redispersible or redispersible NCEs can be added at concentrations ranging from about 1 wt % to about 10 wt %; addition of these NCEs can be done directly from low concentration suspensions (˜2 wt %), or can be added in dried form and redispersed using the redispersing agents as described herein. The NCEs added to the solution are then mixed until homogeneous. If not added previously, plasticizers can be incorporated at this stage, at concentrations ranging from, for example, about 0.1-1 wt %, about 0.1-10 wt %, about 1 wt % to about 50 wt %, or about 1 wt % to about 10 wt %, or about 5% to about 15%, to impart flexibility. Suitable plasticizers can include, without limitation, glycerol, 1,2-propanediaol, xylitol, erythritol, maltitol, sorbitol, and mannitol. Other additives, such as odor-related additives, can be incorporated into the mixture as desired. This formulation, comprising absorbent substances, NCEs and any redispersion polymers, plasticizers, and other desired additives can be folded into the cellulosic substrate material and mixed thoroughly to form the precursor substance that is to be formed into articles of manufacture. The amount of cellulosic substrate material used is determined in part by the desired viscosity of the precursor material, the desired cost, and the desired level of absorption.

Techniques for forming the precursor material into articles of manufacture include extrusion, injection, blowing, airlaying, spinning, rolling, pressing, molding, pelletizing, or combinations thereof, and any other methods familiar to those of skill in the art. In one embodiment, sheets can be formed, for example by mixing the precursor material in a homogenizer or an extruder, and feeding the formulation into a slot die. The resulting sheets or articles can be further processed: for example, they may undergo drying methods (convection, microwave, steel belt), coating methods (spray-on, roll-on, lamination,) molding methods (i.e. thermoforming, pressing, perforation, shaping, forming), printing methods, and the like. In other embodiments the formulation is prepared to mimic the size, shape, density, and/or absorption characteristics of superabsorbent polymer (SAP) beads such as sodium polyacrylate beads, providing a replacement for SAPs in current manufacturing equipment, such as the specialized diaper air laying machines. In embodiments, for example, the formulation can be sized in sizes that are similar to SAP beads used in absorbent products like diapers, having a size range from about 0.1-10 mm, for example, 100-900 micrometers, which can be foamed or not foamed.

B. Articles of Manufacture Made from Biodegradable Absorbent Materials

Materials formed according to the principles of the invention can be used for any absorbent purpose, for example to remove and sequester undesired fluids, or to store and make available beneficial fluids. A wide variety of articles of manufacture incorporating such materials that are made according to the principles of the invention are available for a wide variety of such purposes, offering consumers an environmentally friendly, high-performing alternative to conventional absorbent products.

Fluid-removal products take up, retain, and sequester undesirable fluids. The aim of fluid-removal products is to remove an undesirable fluid from where that fluid has been expelled, secreted, dispensed, spilled, or otherwise delivered. Such products fall into a number of general categories such as baby diapers, adult incontinence absorbers, feminine hygiene products, paper towels, pet care products, agricultural products, food service items, home cleaning products, personal cleaning and care products, general-purpose bedding materials and linens, sanitary bedding and hospital absorbent products, wound care products and the like. Fluid-removal products currently exist in biodegradable and non-biodegradable forms. Non-biodegradable materials for these products typically offer superior performance features such as absorbency, durability, and moisture retention properties, as well as low cost.

Fluid-delivering products are employed to contain and retain useful fluids and deliver them to targets. Such products currently exist in both non-biodegradable and biodegradable versions for cosmetic uses, medical uses, and agricultural uses such as mulch films, water retention, soil conditioners, and delivery vehicles for active agents (e.g., pesticides for agricultural uses that can be delivered directly to agricultural targets in appropriate doses, thus decreasing the need for sprayed pesticides or other topical administrations). While the agriculture market may be more attuned to eco-friendly methods than other sectors of the economy, non-biodegradable products still offer important advantages for all fluid-delivering uses, such as durability, moisture retention, and lower cost.

However, biodegradable products to remove undesired fluids, or to deliver beneficial fluids) can be produced according to the systems and methods disclosed herein, offering commercially viable alternatives to the current conventional, non-biodegradable offerings. Exemplary articles of manufacture consistent with the principles of the invention are described below.

a. Fluid Removal Products: Uptake, Retention and Sequestration of Undesired Fluids

Multiple types of products exist to take up, retain, and sequester undesired fluids so that these fluids can be collected apart from where they are produced and can ultimately be removed as waste materials. Such products are referred to herein collectively as “fluid removal products.” As described above, however, non-biodegradable materials used for these purposes become virtually permanent fixtures in waste disposal sites, persisting for several hundred years before decomposing. Biodegradable materials are thus desirable for these purposes, provided that such materials can demonstrate satisfactory performance.

Pet care products illustrate a market offering in which the biodegradable absorbent materials disclosed herein can offer a viable alternative to conventional non-biodegradable products. Absorbent materials are incorporated into a wide variety of pet care products, helping owners keep their pets and their living spaces clean and hygienic. Many pet care products are analogous to similar products intended for human use: for example, pet training pads and other fluid absorbers (bedding, cage liners, incontinence pads, absorbent mats and towels, and the like) are designed to take up excretions and spills and retain them so that they can be removed as waste products. Cat owners, however, require a more specialized product for pet waste management that is designed to meet the needs of this species.

Without being bound by theory, it is understood that house cats, descended from desert-dwelling wild cats, instinctively bury their waste products to hide their scent from predators; litter boxes and absorbent litter for litter boxes (i.e., “kitty litter” or “cat litter,” which terms can be used interchangeably) are designed to adapt this instinctual behavior to the human environment. Therefore, kitty litter has particular features that meet both feline and human performance requirements. Features such as odor control, clumping, texture, disposability, and product integrity with minimal dust formation are important so that both the cat and the cat owner are satisfied with the product.

Currently there are many varieties of materials commonly used in cat litter products, such as clay, paper pellets, silica crystals, tofu, grass, wheat, and others. Clay is the most popular cat litter choice and can be found in clumping and non-clumping formulations. While it is easy to use and can incorporate additives that mask the smell of cat excretions, it becomes increasingly dusty during prolonged use, so that it can be tracked through the house and can even cause respiratory problems in the pet and decrease air quality for the owners. Paper pellet litter is more environmentally friendly but needs to be changed more often and does little to combat undesirable odors. Crystal cat litter is easy to use, has fewer dust issues than its clay counterpart, and can mask odor, but it is made of inorganic materials that will not biodegrade. Biodegradable forms of cat litter have been commercialized, but have a variety of performance-related problems. Thus, the pet products industry is looking for an alternative cat litter that masks odor, is easy to use, does not break down to form dust, and is biodegradable.

The biodegradable absorbent materials as disclosed herein can be used to form cat litter having these desirable properties. In embodiments, a biodegradable absorbent cat litter can be formed from a cellulosic substrate material, an absorption solution comprising a water-swellable substance, a plasticizer, and an odor-related or odor-controlling agent. Advantageously, such a biodegradable absorbent cat litter can be formed from a cellulosic substrate material, an absorption solution such as a mixture comprising one or more water-swellable absorbent substance, a plasticizer, an odor-related or odor-controlling agent, and optionally non-redispersible or redispersible NCEs. In an illustrative embodiment, the cellulosic substrate material can be an agricultural waste product such as coffee grounds, wood flour, wood chips, saw dust, bagasse pulp, hardwood and softwood pulp, beet fiber grounds, ground rice hulls, banana fiber, bamboo fiber, lignin, hemp fibers, recycled pulp, or any combination of the foregoing, although other cellulosic substrate materials can also be used.

Additives, such as have been described above, can be incorporated in the cat litter formulation to add other desirable properties to the product. For example, odor control can be added to the product by selecting additives having odor-related properties, using any single ingredient or combination of ingredients such as sodium carbonate, sodium bicarbonate, activated charcoal, enzymes (such as without limitation proteases and amylases), acetic acid, silica, bentonites, polyamines, modified polyamines, and the like. Examples of suitable polyamines include substances such as amine-containing polysaccharides, amine-containing polypeptides, polyethylenimine, polyethylenimine derivatives, poly(vinylamine), poly(diallylamine), poly(allylamine), copolymers of diallylamine and allylamine, copolymers containing diallylamine or allylamine, and condensation polymers formed from polyamine monomers and monomers with two or more amine-reactive groups. Additionally, encapsulated fragrances (for example, using cyclodextrins) and naturally scented oils can provide odor control and can introduce pleasant odors as substitutes for undesirable ones.

Other oils, with or without fragrances, can also be employed to diminish dust formation for cat litter products, and redispersible or non-redispersible NCEs can be added to prevent dust formation as well as to enhance strength. Additionally, antimicrobial agents (e.g., antifungal, and antibacterial agents) can be included to slow microbially-mediated degradation of the products and decrease emission of unpleasant odors. Such agents include, without limitation, hemp, clay minerals, organic acids such as lactic acid, acetic acid, sorbic acid, benzoic acid, propionic acid, humic acid, and the like, nisin, natamycin, sulfites, sulfur dioxide, and sodium chloride, boric acid, and sodium borate (borax). Additives selected for incorporation into cat litter products are preferably non-toxic to animals who may encounter the product, and are non-irritating to skin and fur.

After appropriate additives have been selected, a surfactant and a plasticizer can be added to compatibilize the ingredients, decrease viscosity while mixing and encourage foaming. For example, an anionic surfactant or an anionic polymer can be selected to discourage adhesion to the keratin of cat hair, thus decreasing the likelihood of litter tracking throughout the pet's residence or other space.

As an exemplary embodiment of an absorbent formulation suitable for cat litter products, HEC and HPMC can be selected as the water-swellable absorbent substances, and mixed together in an 80:20 ratio, making up 1-10%, for example 5%, of the overall biodegradable absorbent material. Capryl glucoside can be selected as the surfactant, and added in an amount that provides a 3:2 ratio of the absorbent substance mixture to surfactant, making up 0.5-10 wt %, for example 6 wt %, of the overall material. Glycerol can be selected as the plasticizer, and added in an amount that provides a 95:5 ratio of the absorbent substance mixture to the glycerol, making up 0.1-5 wt %. Sodium carbonate and/or activated charcoal can be added in an amount between 1% and 10%, for example 4%, of the overall biodegradable absorbent material. Optionally, redispersible NCEs (preferably nanofibrillated cellulose, microfibrillated cellulose or some combination thereof, with or without their redispersing agents) or non-redispersible NCEs can be added to the overall biodegradable absorbent material in an amount of about 0.1 to about 10 wt % NCEs, for example, 1 wt %. Pulp of one or multiple sources can be added to the mixture from about 20 to about 95%, for example 90%.

In another exemplary embodiment, HEC and HPMC can be selected as the water-swellable absorbent substances, and mixed together in an 80:20 ratio, making up about 1.2% of the overall biodegradable absorbent material. Capryl glucoside can be selected as the surfactant, and added in an amount that provides a 3:2 ratio of the absorbent substance mixture to surfactant. Glycerol can be selected as the plasticizer, and added in an amount that provides a 95:5 ratio of the absorbent substance mixture to the glycerol. Sodium carbonate or activated charcoal can be added in an amount between about 1% and about 5% of the overall biodegradable absorbent material. Optionally, redispersible NCEs (preferably nanofibrillated cellulose, microfibrillated cellulose or some combination thereof, with or without their redispersing agents) or non-redispersible NCEs can be added to the overall biodegradable absorbent material in an amount of about 5 wt % NCEs.

In this exemplary embodiment, the non-redispersible or redispersed/redispersible NCEs can be added to the water-swellable absorbent substances and mixed vigorously to create a homogeneous solution. Next, the cellulosic substrate material and odor controller can be added to this solution and mixed to homogeneity, along with the surfactant and plasticizer. The precursor material prepared as described above is of a viscosity that permits further molding to form the cat litter pellets or strands. In a preferred embodiment, the precursor material can be fed into an extruder and extruded as strands that can then be cut or molded into the desired three-dimensional shapes such as pellets, granules, spheres, hemispheres, cylinders, and/or cubes of varying sizes and shapes (with length and aspect ratio selected to optimize absorbency and handling, and to decrease the product's tracking outside the litter box), smaller elongate strands, or other shaped or crumbled pieces. The formulation may also be prepared and then injection molded, or injected into a dimensionally suitable mold and dried, employing methods familiar to those skilled in the art. The resulting final shaped product can absorb many times its weight in liquid.

The precursor material prepared as described above may also be prepared and molded for other absorbent applications, e.g., by passing it through a slot die to yield sheets of absorbent composite materials. Sheets are particularly advantageous for use in products such as incontinence pads or other absorbing pads (feminine products, medical products, wound dressings, and the like). The absorbent precursor material can optionally be coated, sprayed, laminated, or layered, on one or multiple sides with a biodegradable hydrophobic layer which could consist of cellulose acetates, rosins, zein, lignins, cellulose derivatives, NCEs and the like. Such spraying can improve the retention of the absorbed waste material, and prevent its extravasation into unwanted areas.

b. Fluid-Delivering Products: Delivering Beneficial Fluids

Multiple types of products exist to retain and deliver beneficial fluids; such products are referred to herein as “fluid-delivering products.” Non-biodegradable absorbent products are commonly used for such purposes. As described above, however, non-biodegradable materials used for these purposes can become virtually permanent residents in waste disposal sites after they have served their intended purpose. Biodegradable materials are thus desirable for these purposes, provided that such materials can demonstrate satisfactory performance.

Some fluid-delivering products can combine absorbency with the delivery of beneficial fluids. For example, a wound dressing formed from a biodegradable absorbent material can absorb fluid from a wound and then retain and release the fluid in the vicinity of the wound to create a physiologically moist environment that facilitates healing. Calcium alginate, currently used for wound dressings, can also be added to the biodegradable absorbent material to support the formation of this physiological environment. Other additives can be included in the product for bacteriostatic effect, or to carry out other physiological functions. For example, hemostatic agents can be included in the dressing such as human fibrinogen, human thrombin, calcium chloride and the like, to induce blood clotting when the dressing is applied to a wound.

Fluid-delivering materials intended to retain and deliver beneficial fluids in keeping with the principles of the invention can be used for a variety of other purposes, such as the delivery of an active agent (e.g., a pharmaceutical agent or personal care product) to a targeted site. In such embodiments, the biodegradable absorbent material can be contacted with the desired additive so that the material becomes imbued with the additive, and the material acts as a carrier for the additive. The absorbent material may be loaded with personal care active agents, before, during, or after drying. After application of the fluid-delivering product to the targeted site, the additive can diffuse through the product's substrate to come into contact with the surface of the site, for example the skin or the surface of the organ. The contact allows the additive to affect the surface itself or, under certain conditions, to penetrate the surface and affect the tissues underneath. The ability of a fluid-delivering material to act as a carrier for beneficial additives allows it to be used for medical or veterinary purposes, to deliver pharmaceutical agents that affect surfaces such as the skin, or that pass through such surfaces, permitting (for example) transdermal delivery of the pharmaceutical agent. The fluid-delivering material can also permit a timed release of the agent it carries. For example, the evaporation of the fluid medium within the product over time can lead to decreased diffusion of the active agent over time until the material dries and the diffusion ceases.

Fluid-delivering materials as disclosed herein can act as carriers for personal care products in fluid form intended for immediate application to a targeted body surface, such as cosmetics or sunscreens, offering a convenient and tidy method for storing and applying such products. Fluid-delivering materials as disclosed herein can also support active agents useful for personal care, such as skin treatment products, cosmetic products, skin care and skin cleansing products, moisturizing products, and the like. These personal care active agents can include any product suitable for application to a skin surface, such as surfactants, humectants, activated charcoal, niacinamide, benzoyl peroxide, emollients, ceramides, salicylic acid, glycerol, vitamin oils and their derivatives (e.g., retinols), plant oils and plant-derived chemicals (e.g., resveratrol) and the like. Foaming agents and stabilizers can be added to enhance foaming and lather of the product during use. As an example, moisturizing agents and/or exfoliating agents can be absorbed into the water-swellable material, which can then be applied to the targeted skin site. Such agents can be incorporated into a fluid-delivering material designed for prolonged application (as in overnight face masks), or can be applied for shorter periods of time.

In another exemplary embodiment, a dried or partially dried absorbent material containing the personal care active agent can be re-wetted by the consumer and applied to the desired target area. In this situation, the fluid-delivering product comprises a dried or partially dried absorbent material that absorbs a rewetting fluid and delivers it secondarily to the designated target area. The term “rewetting fluid” as used herein refers to a fluid that is deliberately applied to the dried or partially dried absorbent material, for example by a consumer who wets the absorbent material to resuspend the personal care products or active agents embedded in the absorbent material. For example, a face wash or mask in any form (e.g. a foamed cube or sheet) could be wetted and rubbed into a paste or foamy wash, either in the consumer's hands or directly applied/rubbed into one's face: in this case, water is the rewetting fluid, and it serves to fluidize the soap products or other personal care products that are carried within the dried or partially dried cube, sheet, face mask or the like. This provides a convenient, plastic-free way to transport and sell personal care products for consumer use. Also, since the weight of the overall product is significantly decreased by removing the water, costs and greenhouse gas emissions associated with shipping are also decreased.

In embodiments, active agents commonly found in conventional personal care products can be incorporated in absorbent materials to be used for personal care purposes. Common active agents in personal care products can include commonly used surfactants, cleansing acids (e.g. salicylic acid, glycolic acid), foaming agents (such as without limitation myristic oxide and betaine), foam stabilizers, emulsification agents, thickeners (such as without limitation, NCEs, cellulose polymers, and gums), chelation agents such as EDTA, MGDA, vitamin oils and their derivatives, and the like.

Fluid-delivering products intended to retain and deliver beneficial fluids are especially useful in agricultural and horticultural settings, delivering water to plants, improving soil quality, and overall facilitating plant growth while offering protection against damaging influences such as pest invasion, drought, soil erosion, and nutrient deficiency. For example, such absorbent materials can be used to improve water retention in the soil by holding moisture around the base of plants so that it enters the soil, thus decreasing the amount of extrinsic irrigation that is required. When solutions of water-soluble nutrients are introduced into the absorbent material and retained therein, these nutrients can be dispensed into the soil over time as the fluid that has been retained is released. As used herein, the term “agricultural target” can be used to describe any plant, leaf, fruit, vegetable, seed or seed case, stem or other plant part, soil, growth medium, or other agricultural substrate towards which the retention and delivery aspects of fluid-delivering products can be directed.

Fluid-delivering materials intended to retain and deliver beneficial fluids to agricultural targets in agricultural and horticultural settings are desirably biodegradable in order to avoid the environmental challenges attributable to non-biodegradable materials. Moreover, in the agricultural and horticultural setting, it is advantageous to have absorbent materials biodegrade in situ, not only to avoid having to remove the spent materials after their fluids are discharged, but also to allow the materials themselves to act as carriers for other beneficial additives that can be incorporated into the soil as the materials decompose. Such additives can include nutrients, pesticides, pheromones, and the like, which can be embedded in the absorbent material and then dispersed into the soil as the absorbent material degrades.

Advantageously, biodegradable absorbent materials in keeping with the principles of the invention can be prepared as films or sheets. Films and sheets having absorbent properties can be pre-loaded with water or water-soluble nutrients, with those additives being delivered into the environment on a pre-programmed timetable. Films and sheets having absorbent properties can also be positioned around the plants being cultivated in order to absorb excess rainfall to prevent oversaturation of the soil, with the absorbed rainfall then being redispersed into the soil in a more controlled manner as the absorbent material releases its contents. In more specialized applications, absorbent materials can be used as support structures for seed germination, providing a protective environment for the seeds and supplying them with moisture and nutrients as they begin to germinate and establish roots. In other specialized applications, absorbent materials are used in hydroponic and container gardening systems, supporting seed germination and providing moisture and nutrients for the growing plants.

In embodiments, biodegradable absorbent materials as disclosed herein can be prepared for use in a variety of agricultural and horticultural settings, addressing the needs of a variety of agricultural targets. In general, a cellulosic substrate material as described previously can be combined with one or more water-swellable absorbent substances, and with optional non-redispersible or redispersible NCEs. To this basic mixture, additives can be included as required for specific growing conditions. Once the mixture has been prepared, it can be rolled into sheets for positioning on top of or around growing plants. In embodiments, seeds can be introduced into the mixture before or after rolling into sheets, if the resulting biodegradable absorbent material is to be used as a matrix for seed germination. In other embodiments, the sheets can be positioned on top of or around seeds that have been planted or plants that are growing.

The biodegradable absorbent material formed as films or sheets can be infused with a preselected amount of water so that they retain the water in the designated agricultural/horticultural locus, and so that they can then release the retained water gradually over time. Sheets that are pre-infused with water and optionally pre-infused with fertilizers or other nutrients can be formed into composite structures, for example by applying a water-resistant layer on top that can reduce water evaporation from the fluid-infused absorbent material. In certain embodiments, the biodegradable absorbent material, including any desired additives, can be diluted sufficiently such that it can be sprayed around the growing plants, or around already-planted seeds; such biodegradable absorbent material can also be employed for hydroseeding, wherein the material acts as a vehicle for supporting seeds, and beneficially acts as a mulch as well as a vehicle for dispensing water to the seed population over time.

In addition, while the behavior of rewettable dried absorbent material has been described above by reference to personal care products, it is understood that the same approach can be used for other applications, such as agricultural or horticultural uses, where a dried, water-swellable article loaded with an active agent such as a fertilizer or a pesticide could be rewetted, with release of the active agent into the external environment surrounding the fluid-delivering product. In other embodiments, the biodegradable absorbent material formed as sheets or films can also be positioned as desired without being exposed to water beforehand. In such embodiments water can be delivered into the absorbent material after it is positioned in the agricultural or horticultural setting by watering or irrigation or by natural means such as rainfall, with the absorbed fluid then being released gradually into the environment. In embodiments, the biodegradable absorbent material is mainly intended for use as a mulch or ground cover, to conserve soil moisture by absorbing it, retaining it, and releasing it gradually. Such a sheet can be combined with a water-resistant layer to reduce evaporation.

### EXAMPLES

Materials used in Examples 1-6 include:
NFC suspensions in water (obtained from various sources, including Performance Biofilaments, SAPPI, University of Maine, Auburn University, and Borregaard)
Glycerol
Hydroxypropyl methylcellulose (HPMC), ˜120,000 Mw
Hydroxy ethyl cellulose (HEC), ˜1,300,000 Mw
Capryl glucoside
Activated charcoal (NORIT)
Sodium carbonate
Saw dust
Wood flour
Bagasse Pulp
Softwood Kraft Pulp
Ground rice hulls
Kraft lignin

### Example 1

A water-swellable absorbent solution was prepared as follows:

Ingredients were first measured out, and two solutions were prepared. A first solution was prepared using the absorbing polymers HEC and HPMC, which were selected in amounts to yield an 80:20 ratio of HEC/HPMC. To form the first solution, the absorbing polymers in this ratio were mixed into water in amounts needed to form a 1.2% aqueous solution (by weight). A second solution was prepared by adding glycerol (a plasticizer) to water, in an amount to create a 95:5 ratio of glycerol:absorbing polymers, and homogenizing the solution. Capryl glucoside (a surfactant) was added to this solution in an amount necessary to create a 1.5:1 ratio of surfactant to the amount of absorbing polymers contained in the first solution; the capryl glucoside was mixed thoroughly into the second solution. When both solutions had been prepared, the first solution was mixed slowly into the second solution while mixing both together and homogenizing it. The combination of the first solution and the second solution under these conditions resulted in the binary absorption mixture used in subsequent Examples.

### Example 2

In this experiment, multiple agricultural sources were combined with the binary absorption solution prepared as set forth in Example 1 to determine which made the strongest strands and had the highest absorption. First, the agricultural products listed in Table 1 were weighed out. Next, amounts of the absorbent solution from Example 1 (as listed in Table 1) were added to the dry agricultural product and mixed. The binary absorption solution was added to the specific agricultural product in small amounts until all the dry product was coated, forming a paste-like material. For the finer agricultural product particles such as wood flour, a larger amount of binary absorption solution was needed to coat the material. Next, these pastes were spread out on a sheet and cut, using a blade, into strips. The strips were placed in the oven at 70° C. for 1.5 hours and dried.

The dried strips were weighed to provide a dry weight for each strip. The dried strips were then wetted by placing them in a simulated urine bath (0.9% NaCl in water) for 1 minute to absorb as much water as possible. The strips were taken out of the water bath and weighed to determine a wet weight. The absorption for each sample was determined by dividing the wet weight by the dry weight. Five samples were prepared for each agricultural product. The average absorption value listed on Table 1 for each agricultural product represents the average of the absorptions for the five samples for each product.

TABLE 1

| | | Weight of | Weight of | |
|---|---|---|---|---|
| | Ratio | absorbent | agricultural | Average |
| Agricultural product | absorbent:agricultural | solution (g) | product (g) | absorption |
| wood flour | 3:1 | 13.5 | 4.5 | 3.69 |
| round rice hulls | 2:1 | 6.08 | 3 | 2.34 |
| bagasse fibers | 2:3 | 4 | 6 | 4.58 |
| kraft lignin | 1:2 | 2.5 | 5 | 1.71 |

It was determined that the wood flour and bagasse samples had the highest absorption of all the samples, and by inspection these samples had the best structural integrity. These two agricultural products were then used in the various combinations described in Example 3.

### Example 3

In this experiment, absorbent materials made from agricultural products formed from various ratios of wood flour (WF) to bagasse (Bag) were tested to assess their structural integrity and absorption capacity. To prepare these absorbent materials, the binary absorbent solution as prepared in Example 1 was combined with mixtures of wood flour and bagasse. Ratios of 1:9, 3:7, and 5:5 wood flour to bagasse were tested, as listed in Table 2. In each case, a 2:1 ratio by weight of the absorbent solution to agricultural product was used.

The strips of absorbent material were prepared and dried in the same way as was presented in Example 2. The dry weight of each dried sample was determined. The dried strips were then wetted as described in Example 2, and their wet weights were measured. Average absorption was determined by dividing the wet weight by the dry weight, and then averaging the absorption for all the members of each sample set, with the results shown in Table 2.

TABLE 2

| | | | | | | Average |
|---|---|---|---|---|---|---|
| | | | | | Absorption | absorption |
| Test | Ratio | Trial | Initial | Final | (final wt/ | for each |
| Number | WF:Bag | number | weight | weight | initial wt) | test |
| 1 | 1:9 | 1 | 0.55 | 2.38 | 4.327 | |
| | | 2 | 0.44 | 2.01 | 4.568 | |
| | | 3 | 0.35 | 1.7 | 4.857 | 4.63 |
| | | 4 | 0.31 | 1.51 | 4.871 | |
| | | 5 | 0.51 | 2.31 | 4.529 | |
| 2 | 3:7 | 1 | 0.63 | 2.44 | 3.873 | |
| | | 2 | 0.4 | 1.75 | 4.375 | |
| | | 3 | 0.41 | 1.73 | 4.220 | 3.97 |
| | | 4 | 0.58 | 2.28 | 3.931 | |
| | | 5 | 0.85 | 2.94 | 3.459 | |
| 3 | 5:5 | 1 | 0.74 | 2.89 | 3.905 | |
| | | 2 | 0.68 | 2.68 | 3.941 | |
| | | 3 | 0.66 | 2.81 | 4.258 | 4.05 |
| | | 4 | 0.47 | 1.9 | 4.043 | |
| | | 5 | 0.81 | 3.32 | 4.099 | |

Samples prepared for this Example were also assessed for structural integrity. From this experiment, it was observed that a WF:Bag ratio of 5:5 resulted in weak strips that fell apart. Therefore, subsequent Examples used only samples prepared using the WF:Bag ratios of 1:9 and 3:7.

### Example 4

In this Example, NCEs in the form of NFCs were added to the binary absorption mixture of Example 1. Absorbent materials were then formed using this binary absorption mixture as described in Example 3, in order to test the absorption and strength of absorbent materials produced with the inclusion of a NCE additive. The NCE source was a 1000 NFC solution obtained from SAPPI, which was added to the binary absorbent mixture to yield a 500 or 100 concentration of NFCs by weight. As mentioned in Example 3, the ratios of 1:9 and 3:7 WF:Bag were used as the agricultural materials for this Example.

To form the absorbent materials for this Example, the binary absorption mixture of Example 1 was first combined with the NFC solution described above. The NFC solution was whisked into the binary absorption mixture, slightly foaming the overall composition. This foamy mixture was then added to the dry agricultural product mixture of WF and Bag, with both components being mixed thoroughly and then being formed into strips as described in Example 2. The strips were dried and tested for absorption as described in Example 2, and average absorption for each group of samples was calculated, as shown in Table 3.

TABLE 3

| | | | | | | Average |
|---|---|---|---|---|---|---|
| Test | ratio | | | | Absorption | absorption |
| Num- | WF:Bag, | trial | initial | final | (final wt/ | for each |
| ber | % NFC | number | weight | weight | initial wt) | test |
| 4a | 1:9, 5% | 1 | 0.42 | 1.83 | 4.357 | |
| | | 2 | 0.63 | 2.66 | 4.222 | 4.23 |
| | | 3 | 0.49 | 2.02 | 4.122 | |
| 5a | 1:9, 10% | 1 | 0.74 | 2.83 | 3.824 | |
| | | 2 | 0.38 | 1.51 | 3.974 | 3.89 |
| | | 3 | 0.3 | 1.16 | 3.867 | |
| 6a | 3:7, 5% | 1 | 0.52 | 2.2 | 4.231 | |
| | | 2 | 0.69 | 3.14 | 4.551 | 4.62 |
| | | 3 | 0.54 | 2.74 | 5.074 | |
| 7a | 3:7, 10% | 1 | 0.57 | 2.33 | 4.088 | |
| | | 2 | 0.72 | 3.09 | 4.292 | 4.19 |
| | | 3 | 0.66 | 2.77 | 4.197 | |

The samples formed using 5% NFCs and 10% NFCs appeared similar in structural integrity when examined. It was also observed that the 1:9 WF:Bag samples were much stronger than the 3:7 WF:Bag.

### Example 5

In this experiment, samples prepared as described in Example 4 (Tests 4a-7a) were allowed to dry as described in previous Examples, and then rewetted after three days. After the rewetting, the absorption of the samples was measured, as described in previous Examples. The data for these rewetting experiments is shown in Table 4.

As shown in Table 4, and as compared to Table 3, samples prepared as described in these Examples can be dried and rewet, still retaining most of their absorptive capacity. It was observed that, after rewetting, the samples still had sufficient structural integrity to hold their shape for a period of time.

TABLE 4

| | | | | | | Average |
|---|---|---|---|---|---|---|
| Test | ratio | | | | Absorption | absorption |
| Num- | WF:Bag, | trial | initial | final | (final wt/ | for each |
| ber | % NFC | number | weight | weight | initial wt) | test |
| 4b | 1:9, 5% | 1 | 0.44 | 1.87 | 4.25 | |
| | | 2 | 0.66 | 2.74 | 4.15 | 4.15 |
| | | 3 | 0.48 | 1.94 | 4.04 | |
| 5b | 1:9, 10% | 1 | 0.78 | 3.00 | 3.85 | |
| | | 2 | 0.42 | 1.51 | 3.60 | 3.61 |
| | | 3 | 0.25 | 0.85 | 3.40 | |
| 6b | 3:7, 5% | 1 | 0.50 | 2.23 | 4.46 | |
| | | 2 | 0.75 | 3.06 | 4.08 | 4.26 |
| | | 3 | 0.51 | 2.16 | 4.24 | |
| 7b | 3:7, 10% | 1 | 0.73 | 2.75 | 3.77 | |
| | | 2 | 0.76 | 3.15 | 4.14 | 3.84 |
| | | 3 | 0.51 | 1.84 | 3.61 | |

### Example 6

Two mixtures (Mixture 1 and Mixture 2) were prepared, molded and baked to form samples for testing. The preparation of the two mixtures was the same until the step (2 and 4) where the bagasse was added. Mixture 1 had a bagasse fiber loading of 88% (on dry weight basis), and an absorbing polymer loading of 5%, while Mixture 2 had a bagasse fiber loading of 79% (on dry weight basis) and an absorbing polymer loading of 9%. As described below, an absorbing solution (2 g dry weight mixture of HEC, HPMC, softwood kraft, saw dust, NFC, capryl glucoside, and glycerol in 98 g of water) was prepared and combined with 15 g (dry weight) of bagasse in Mixture 1. The same absorbing solution was prepared again and combined with 7.5 g (dry weight) of bagasse in Mixture 2. Both Mixtures had the same amount of the absorbing solution and its components; the only difference between the two mixtures was the quantity of bagasse fiber added. The samples produced from each of the Mixtures prepared according to the methods of this Example were then evaluated for absorption and density, the results of which are set forth in Table 5 below.

For both Mixtures (Mixture 1 and Mixture 2), Step 1 was carried out as follows to prepare the absorbing solution:
98 g of water was heated to 70° C., and 0.572 g of capryl glucoside, and 0.042 g of glycerol were added to the hot water while mixing. Then, 0.686 g of HEC (1,300,00 Mw) and 0.172 g of HPMC (120,000 Mw) were dry-mixed and added to this hot aqueous solution. Once the solution cooled and the absorbing polymers were well solubilized, 3.33 g of 3% Valida L NFC (0.1 g dry weight) was added and mixed until well incorporated (no clumps). Then 9.65 g of 4% softwood kraft pulp (0.386 g dry weight) was added, followed by 0.042 g of sawdust. This combination yielded an absorbing solution containing 2 g (dry weight) of the additives (capryl glucoside, glycerol, HEC, HPMC, NFC, softwood kraft pulp, and sawdust) per 100 g of the solution. This absorbing solution was then combined with bagasse to prepare Mixture 1 and Mixture 2.

To produce samples from Mixture 1, Steps 2 and 3 were performed:
Step 2: 50 g of a 30% solids bagasse formulation (i.e., a formulation of 30% bagasse solids and 70% water, with 50 g of the formulation yielding 15 g dry weight bagasse) was mixed with 100 g of the absorbing solution that was prepared in Step 1, using a T25 overhead IKA homogenizer at ˜15,000 rpm. This yielded Mixture 1.
Step 3: Mixture 1 was then spread into silicone molds, and baked at 85° C. in the oven until dry.

To produce samples from Mixture 2, Step 1 was repeated, and then Steps 4 and 5 were performed.
Step 4: 25 g of the 30% solids bagasse formulation described above (yielding 7.5 g dry weight bagasse) was mixed with the 100 g of the absorbing solution that was prepared in Step 1, using a T25 overhead IKA homogenizer at ˜15,000 rpm. This yielded Mixture 2.
Step 5: Mixture 2 was then spread into silicone molds, and baked at 85° C. in the oven until dry.

The resulting molded dry final absorbing articles were both relatively low density as compared to other absorbent products used, for example, as traditional cat litters. However, the formulation with the lower bagasse fiber content was more easily mixed and aerated using the homogenizer, had the lower average density (˜0.055 g/cc as opposed to 0.095 g/cc), and had the higher average (weight normalized) absorption multiplier (˜15 times its weight in water as opposed to ˜11 times its weight in water). The absorption multiplier was calculated using the following equation:

$$Water Absorption Multiplier = ( Final weight - Initial weight ) / Initial weight$$

Using these parameters, the samples produced according to the methods of this Example were evaluated for absorption and density. The results are set forth in Table 5 below.

TABLE 5

| | | | Final Wet | | | | |
|---|---|---|---|---|---|---|---|
| | | Initial | Weight | | | | Average |
| | Trial | Dry | (fully | Absorption | Average | Density | Density |
| Sample Info | Number | Weight | saturated) | Multiplier | Absorption | (g/cc) | (g/cc) |
| .9 cm cube | 1 | 0.0651 | 0.9019 | 12.85407066 | 11.3 | 0.08930041152 | 0.09211248285 |
| Mixture 1 | 2 | 0.0675 | 0.755 | 10.18518519 | | 0.09259259259 | |
| | 3 | 0.0672 | 0.8921 | 12.27529762 | | 0.09218106996 | |
| | 4 | 0.0681 | 0.9249 | 12.5814978 | | 0.09341563786 | |
| | 5 | 0.0678 | 0.84 | 11.38938053 | | 0.09300411523 | |
| | 6 | 0.0672 | 0.875 | 12.02083333 | | 0.09218106996 | |
| 1.2 cm | 1 | 0.0482 | 0.5566 | 10.54771784 | | 0.1065453925 | 0.09951604914 |
| (diameter) | 2 | 0.0427 | 0.5349 | 11.52693208 | | 0.09438772319 | |
| half sphere | 3 | 0.0392 | 0.5303 | 12.52806122 | | 0.08665102457 | |
| Mixture 1 (15 | 4 | 0.049 | 0.5108 | 9.424489796 | | 0.1083137807 | |
| gms bagasse) | 5 | 0.046 | 0.461 | 9.02173913 | | 0.1016823248 | |
| .9 cm cube | 1 | 0.0517 | 0.8911 | 16.23597679 | 15.3 | 0.07091906722 | 0.06815272062 |
| Mixture 2 (7.5 | 2 | 0.0492 | 0.8888 | 17.06504065 | | 0.06748971193 | |
| gms bagasse) | 3 | 0.0488 | 0.815 | 15.70081967 | | 0.06694101509 | |
| | 4 | 0.0507 | 0.658 | 11.97830375 | | 0.0695473251 | |
| | 5 | 0.0494 | 0.8812 | 16.83805668 | | 0.06776406036 | |
| | 6 | 0.0483 | 0.7185 | 13.8757764 | | 0.06625514403 | |
| .125 mL | 1 | 0.007 | 0.091 | 12 | 15.1 | 0.0522227157 | 0.04749780333 |
| hemisphere | 2 | 0.006 | 0.0995 | 15.58333333 | | 0.04476232774 | |
| (r = 4 mm) | 3 | 0.0065 | 0.103 | 14.84615385 | | 0.04849252172 | |
| Mixture 2 | 4 | 0.0065 | 0.102 | 14.69230769 | | 0.04849252172 | |
| | 5 | 0.0054 | 0.0947 | 16.53703704 | | 0.04028609497 | |
| | 6 | 0.0068 | 0.1223 | 16.98529412 | | 0.05073063811 | |

While this invention has been particularly shown and described with references to preferred embodiments thereof, it will be understood by those skilled in the art that various changes in form and details may be made therein without departing from the scope of the invention encompassed by the appended claims. All United States patents and published or unpublished United States patent applications cited herein are incorporated by reference. All published foreign patents and patent applications cited herein are hereby incorporated by reference. All other published references, documents, manuscripts and scientific literature cited herein are hereby incorporated by reference. The relevant teachings of all patents, published applications, and references cited herein are incorporated by reference in their entirety.

1. A biodegradable absorbent material, comprising:
a cellulosic substrate comprising a lignocellulosic material;
a water-swellable absorbent polysaccharide polymer mixture, wherein the polysaccharide polymer mixture comprises hydroxyethyl cellulose and hydroxypropyl methylcellulose, and wherein the water-swellable absorbent polysaccharide polymer mixture permeates the cellulosic substrate; and
one or more additives selected from the group consisting of performance-improving additives, additives to produce specific functionalities, plasticizers, and surfactants, wherein the one or more additives permeate the biodegradable absorbent material.

2. The biodegradable absorbent material of claim 1, wherein the lignocellulosic material is selected from the group consisting of virgin biomass materials, waste materials from agriculture, waste materials from forestry, forestry pulp products, tree-free pulp products, and specialty purpose crop materials.

3. The biodegradable absorbent material of claim 2, wherein the lignocellulosic material comprises an agricultural waste material.

4. The biodegradable absorbent material of claim 1, wherein the one or more additives permeate the biodegradable absorbent material in a substantially uniform distribution.

5. The biodegradable absorbent material of claim 1, wherein the one or more additives comprises a performance-improving additive.

6. The biodegradable absorbent material of claim 5, wherein the performance-improving additive comprises fibers or fillers.

7. The biodegradable absorbent material of claim 6, wherein the fibers or fillers are nanoscale fibers or nanoscale fillers.

8. The biodegradable absorbent material of claim 7, wherein the nanoscale fibers are cellulose nanofibers or cellulose microfibers, or combinations thereof.

9. The biodegradable absorbent material of claim 8, at least one of the cellulose nanofibers or cellulose microfibers has been rendered redispersible by the addition of a drying/dispersal additive to a formulation comprising the cellulose nanofibers or cellulose microfibers, wherein the drying/dispersal additive is selected from the group consisting of temperature-responsive polymers, small molecule additives in volatile systems, and blocking agents.

10. The biodegradable absorbent material of claim 1, wherein the one or more additives comprises an additive to produce specific functionalities.

11. The biodegradable absorbent material of claim 10, wherein the additive is an odor-related additive, and the odor-related additive is an odor controller.

12. The biodegradable absorbent material of claim 10, wherein the additive is an antimicrobial agent.

13. The biodegradable absorbent material of claim 10, wherein the additive is a clumping-producing additive or an indicator additive.

14. An article of manufacture, comprising the biodegradable absorbent material of claim 1.

15. The article of manufacture of claim 14, wherein the article is formed as a sheet or a film.

16. The article of manufacture of claim 14, wherein the article is formed as a pellet, granule, bead, sphere, hemisphere, cylinder, strand, or cube.

17. The article of manufacture of claim 14, wherein the article is a fluid-removal product.

18. The article of manufacture of claim 17, wherein the fluid-removal product is a pet-care product.

19. The article of manufacture of claim 18, wherein the pet-care product is a cat litter product.

20. The article of manufacture of claim 14, wherein the article is a fluid-delivering product.

21-29. (canceled)

30. A method of preparing a material having water-swellable absorbent properties, comprising
providing a first aqueous solution comprising hydroxyethyl cellulose and hydroxypropyl methylcellulose;
providing a second aqueous solution comprising glycerol and at least one additive;
mixing the first aqueous solution and the second aqueous solution to form a binary absorption solution;
adding a cellulosic substrate material to the binary absorption solution; and
mixing the cellulosic substrate material and the binary absorption solution to form the material having water-swellable absorbent properties.

31. The method of claim 30, wherein the hydroxyethyl cellulose and the hydroxypropyl methylcellulose are provided in a ratio from about 50:50 to about 95:5.

32. The method of claim 30, wherein the at least one additive is selected from the group consisting of a plasticizer, an odor-related or odor-controlling agent, a clumping-producing additive, and an indicator additive.

33. The method of claim 30, wherein the cellulosic substrate material comprises non-redispersible or redispersible nanocellulose elements.

34. The method of claim 30, wherein the nanocellulose elements are added at concentrations ranging from about 1 wt % to about 10 wt %.

35. The method of claim 30, wherein the cellulosic substrate material comprises agricultural waste.

36. A method of preparing a formed article comprising a material having water-swellable absorbent properties, comprising:
preparing the material having water-swellable absorbent properties according to the method of claim 30 to provide a precursor material for the article of manufacture; and
shaping the precursor material into the formed article.

37. The method of claim 36, further comprising a step of further processing the formed article to yield a finished article of manufacture.

38. The method of claim 37, wherein the step of further processing is selected from the group consisting of drying processes, coating processes, molding processes, and printing processes.

39. The method of claim 37, wherein the step of further processing produces a spherical or ovoid article of manufacture having a size range from about 0.1 mm to about 10 mm.
